(19) United States
(12) Patent Application Publication
(10) Pub. No.: US 2021/0075242 A1
(43) Pub. Date: Mar. 11, 2021

(54) CHARGE AND DISCHARGE CONTROL APPARATUS AND METHOD FOR AN ENERGY STORAGE SYSTEM

(71) Applicant: Institute For Information Industry, Taipei (TW)

(72) Inventor: Jui-Ming WU, Taipei (TW)

(21) Appl. No.: 16/658,024

(22) Filed: Oct. 18, 2019

(30) Foreign Application Priority Data
Sep. 5, 2019 (TW) 108132069

(51) Int. Cl. H02J 7/00

(52) U.S. Cl. CPC H02J 7/0068; H02J 7/0047; H02J 2007/0067; H02J 7/0063; H02J 7/007

(57) ABSTRACT

A charge and discharge control apparatus and method are provided. The charge and discharge control apparatus determines a plurality of adjustment time intervals of a predicted load curve of an electric loop, wherein each adjustment time interval individually corresponds to an adjustment objective. The charge and discharge control apparatus determines a plurality of candidate threshold sets according to the adjustment objectives and a charge and discharge requirement of an energy storage system, wherein each candidate threshold set corresponds to at least one candidate electricity adjustment scheme. The charge and discharge control apparatus determines an objective electricity adjustment scheme from the at least one candidate electricity adjustment scheme so that the energy storage system adjusts the electricity consumption of the electric loop according to the objective electricity adjustment scheme in each adjustment time interval.

### PRIORITY

This application claims priority to Taiwan Patent Application No. 108132069 filed on Sep. 5, 2019, which is hereby incorporated by reference in its entirety.

### FIELD

The present invention relates to a charge and discharge control apparatus and method. More particularly, the present invention relates to a charge and discharge control apparatus and method for an energy storage system (ESS) based on multiple objectives.

### BACKGROUND

Electricity charges collected by electric power companies from customers are generally divided into two categories, i.e., the energy charge and the demand charge. The energy charge is the charge of the total electricity consumed by the customer during a certain period of time (e.g., during a billing month), wherein the unit of the energy is charged by kWh (i.e. kilowatt-hour). With respect to the energy charge, the electric power companies usually implement Time-Of-Use (TOU) pricing systems (i.e., setting different electricity price rates for different time intervals) and, thereby, guiding the customers to reduce the electricity consumption during the peak time interval. As to the demand charge, it is the charge collected by the electric power company according to a maximum demand of the customer during a certain period of time (e.g., during a billing month), wherein the unit of the demand is charged by kW. Different electric power companies calculate “demand” in different ways and, generally, the demand is calculated according to the average electricity consumption power during a certain time interval (e.g., 15 minutes, or longer or shorter than 15 minutes). The electric power company collects a fixed demand charge according to a contracted capacity signed with the customer in advance. The electric power company will collect an additional charge if the maximum demand of the real power consumption of the customer exceeds the contracted capacity. By setting the contracted capacity and collecting the demand charge, the electric power company can more easily control the peak load of the overall electric power system.

Although the electric power companies can control the power supply conditions and the load of the overall electric power system by collecting energy charges and demand charges, sometimes power supply remains tight. To solve this problem, many electric power companies adopt a demand response mechanism. Briefly speaking, if an electric power company predicts that a certain time interval in a certain day will be a time interval of peak demand, the electric power company takes that day as a scheduling day and that time interval of that day as a scheduling time interval. The duration of the scheduling time interval is determined by the electric power company and is not shorter than a minimum load-reduction time interval (e.g., 2 hours). The electric power company will request participating customers to reduce their maximum consumed power within the scheduling time interval of the scheduling day. The electric power company calculates a customer baseline load according to the maximum power consumption of the customers within the same time interval in past several days. If the maximum power consumption within the scheduling time interval of the scheduling day is lower than the customer baseline load, the customer baseline load minus the maximum power consumption within the scheduling time interval of the scheduling day is the load-reduction amount of the demand-response (i.e., the reduced maximum power consumption) of the customers within the scheduling time interval of the scheduling day. Thereafter, the electric power company calculates the reward of the customer according to the load-reduction amounts of the demand-response.

To reduce the energy charge and the demand charge, many consumers use energy storage system (e.g., batteries) to reduce the peak electricity consumption of the power supply system of the electric power company, maintain a stable electricity consumption power, and reduce the maximum demand. Generally speaking, the consumers may charge the energy storage system during the off-peak electricity price period where the electricity price rate is relatively low (or during the off-peak power consumption period where the power consumption is relatively low) and discharge the energy storage system during the peak electricity price period where the electricity price rate is relatively high (or during the peak power consumption period where the power consumption is relatively high). By controlling charging and discharging of the energy storage system, load shifting and peak load shaving can be achieved and thereby reduce the energy charge and the demand charge. Some consumers use energy storage system to earn the rewards regarding the demand response. Specifically, the consumers, on normal days, charge the energy storage system to increase the power consumption (i.e., to increase the customer baseline load) during time intervals that may be designated as the scheduling time interval, discharge the energy storage system in the scheduling time interval of the scheduling day to reduce the energy demand of the consumer, and thereby earn more rewards on the scheduling day.

Some existing technologies adjust power consumption of the load of a consumer by calculating a load prediction curve for the load of the consumer, determining an electricity adjustment scheme according to the load prediction curve, and then charging and discharging the energy storage system according to the electricity adjustment scheme. However, most of the existing technologies consider only one objective (for example, to reduce the load during the peak hours of power consumption, to increase the load during the peak-off hours of power consumption) when determining the electricity adjustment scheme and, hence, are unable to find out the optimal electricity adjustment scheme for controlling the charge and discharge of energy storage system.

In view of this, in order to reduce the demand charge and the energy charge of the consumer, reduce the overall peak load of the power supply systems of an electric power company, and even make the consumer obtain more rewards from load reduction of demand-response, finding a way to determine charge and discharge control of an energy storage system with consideration of multiple adjustment objectives so that load shifting and peak load shaving can be achieved is an urgent task.

### SUMMARY

An objective herein is to provide a charge and discharge control apparatus. The charge and discharge control apparatus may comprise an interface and a processing unit, wherein the interface is electrically connected to an energy storage system and the processing unit is electrically connected to the interface. The processing unit determines a plurality of adjustment time intervals of a load prediction curve of an electric loop, wherein each adjustment time interval individually corresponds to an adjustment objective. The processing unit determines a plurality of candidate threshold sets according to the adjustment objectives and a charge and discharge requirement of the energy storage system, wherein each candidate threshold set corresponds to at least one candidate electricity adjustment scheme. The processing unit further determines an objective electricity adjustment scheme from the candidate electricity adjustment schemes so that the energy storage system adjusts the electricity consumption of the electric loop according to the objective electricity adjustment scheme in each adjustment time interval.

Another objective herein is to provide a charge and discharge control method, which is adapted for an electronic computing apparatus. The electronic computing apparatus may be adapted to control an energy storage system, and the charge and discharge control method may comprise: (a) determining a plurality of adjustment time intervals of a load prediction curve of an electric loop, wherein each adjustment time interval individually corresponds to an adjustment objective; (b) determining a plurality of candidate threshold sets according to the adjustment objectives and a charge and discharge requirement of the energy storage system, wherein each candidate threshold set corresponds to at least one candidate electricity adjustment scheme; and (c) determining an objective electricity adjustment scheme from the candidate electricity adjustment schemes so that the energy storage system adjusts the electricity consumption of the electric loop according to the objective electricity adjustment scheme in each adjustment time interval.

The charge and discharge control technology (including apparatus and method) provided herein sets a plurality of adjustment time intervals for a load prediction curve, and each adjustment time interval can be flexibly set for a corresponding adjustment objective. In the process of determining the objective electricity adjustment scheme, the charge and discharge control technology provided herein considers the adjustment objectives of different adjustment time intervals. Thus, the determined objective electricity adjustment scheme not only satisfies the adjustment objective of each adjustment time interval but also enables the energy storage system to effectively achieve load shifting and peak load shaving and thereby reduce the demand charge and the energy charge of the consumer, reduce the overall peak load of the power supply systems of the electric power companies, and even make the consumer obtain more rewards from load reduction of demand-response.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram showing the architecture of a first embodiment of the present invention.

FIG. 2A to FIG. 2G are diagrams showing how the charge and discharge control apparatus of the first embodiment determines an objective electricity adjustment scheme.

FIG. 3 is a flowchart depicting a charge and discharge control method according to a second embodiment of the present invention.

FIG. 4A and FIG. 4B are flowcharts showing how the charge and discharge control method of the second embodiment of the present invention determines an objective electricity adjustment scheme.

### DETAILED DESCRIPTION

In the following description, a charge and discharge control apparatus and method are provided and explained with reference to certain example embodiments thereof. However, these example embodiments are not intended to limit the present invention to any specific environment, applications, embodiments, examples, or particular implementations described in these example embodiments. Therefore, descriptions of these example embodiments is only for purpose of illustration rather than to limit the present invention. It should be appreciated that, in the following embodiments and the attached drawings, elements unrelated to the present invention are omitted from depiction. In addition, dimensions of individual elements and dimensional scales between individual elements in the attached drawings are provided only for illustration, but not intended to limit the scope of the present invention.

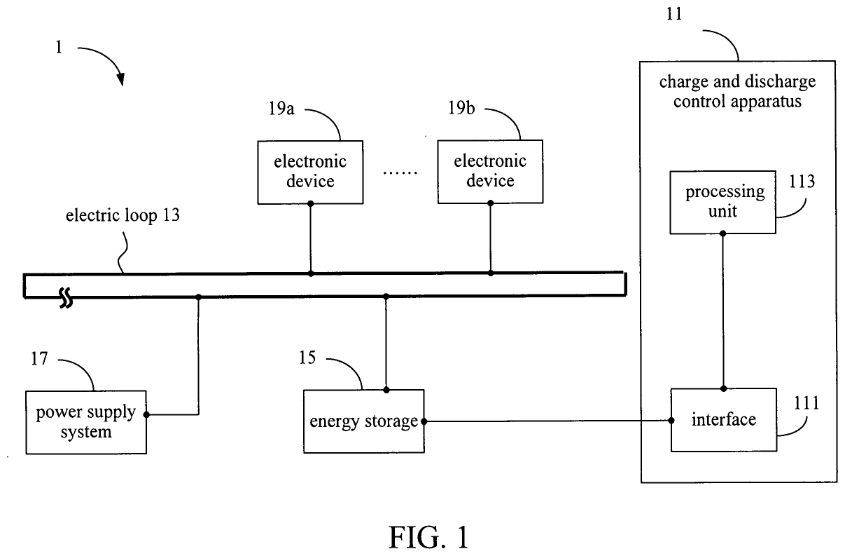

A first embodiment of the present invention is a power consumption system 1 and a schematic view of which is depicted in FIG. 1A. The power consumption system 1 comprises a charge and discharge control apparatus 11, an electric loop 13, an energy storage system 15, a power supply system 17 of an electric power company, and a plurality of electronic devices 19a, . . . , 19b. The energy storage 15 may be one of various storage batteries (e.g. a lead-acid battery, a nickel-hydrogen battery, and a lithium-ion battery) or various types of equipment capable of storing electric energy and capable of charging and discharging. Both the energy storage system 15 and the power supply system 17 are connected to the electric loop 13 and both of them can provide electricity to the electric loop 13. The energy storage system 15 releases electricity to the electric loop 13 according to discharging time intervals and discharging power values decided by the charge and discharge control apparatus 11. Please note that when the energy storage system 15 discharges, the net electricity consumption of the electric loop 13 will be reduced (will be detailed later). In addition, the energy storage system 15 is charged according to charging time intervals and charging power values decided by the charge and discharge control apparatus 11. Please note that when the energy storage system 15 is charged, the net electricity consumption of the electric loop 13 will be increased (will be detailed later). The electronic devices 19a, . . . , 19b may be connected to the electric loop 13 to obtain electricity. It shall be appreciated that the number of electronic devices connected to the electric loop 13 is not limited to any figure in this embodiment. Moreover, the number of electronic devices connected to the electric loop 13 may be different at different time points. Although it is shown in FIG. 1A that the electronic devices 19a, . . . , 19b are connected to the electric loop 13, this is only an example of the operation at a certain time point.

The core of this embodiment is the charge and discharge control apparatus 11. The charge and discharge control apparatus 11 comprises an interface 111 and a processing unit 113. The processing unit 113 is electrically connected to the interface 111, while the interface 111 is electrically connected to the energy storage system 15. The charge and discharge control apparatus 11 may be one of various apparatuses capable of electronic computation (e.g., various computers and servers). The processing unit 115 may be a central processing unit (CPU), a microprocessor, or other computing elements known to those skilled in the art. The interface 111 may be any wired or wireless interface capable of exchanging information with the energy storage system 15.

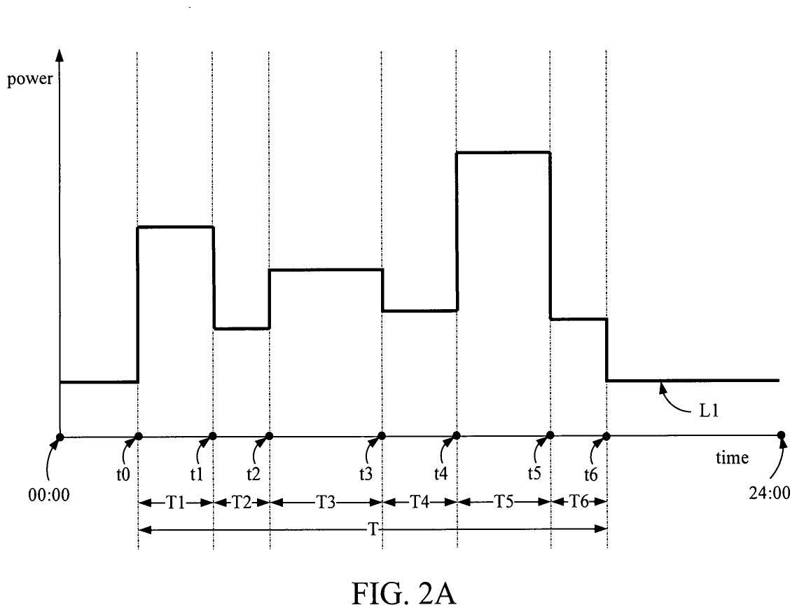

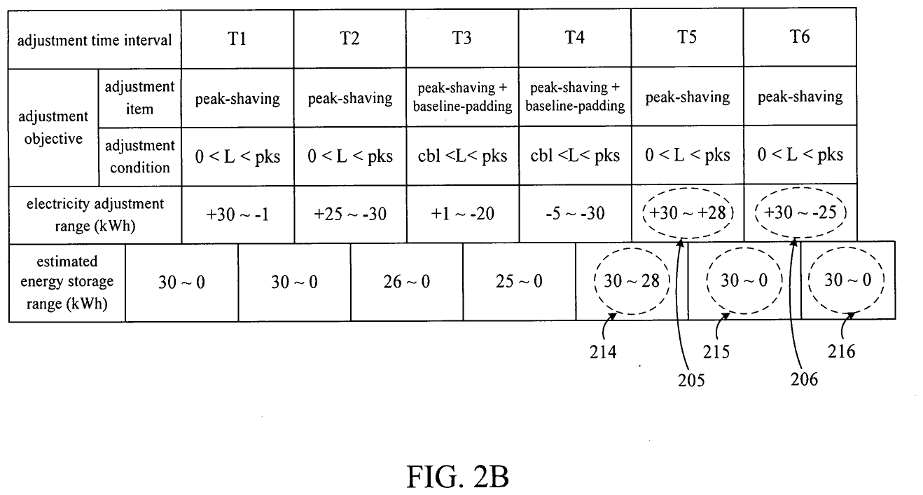

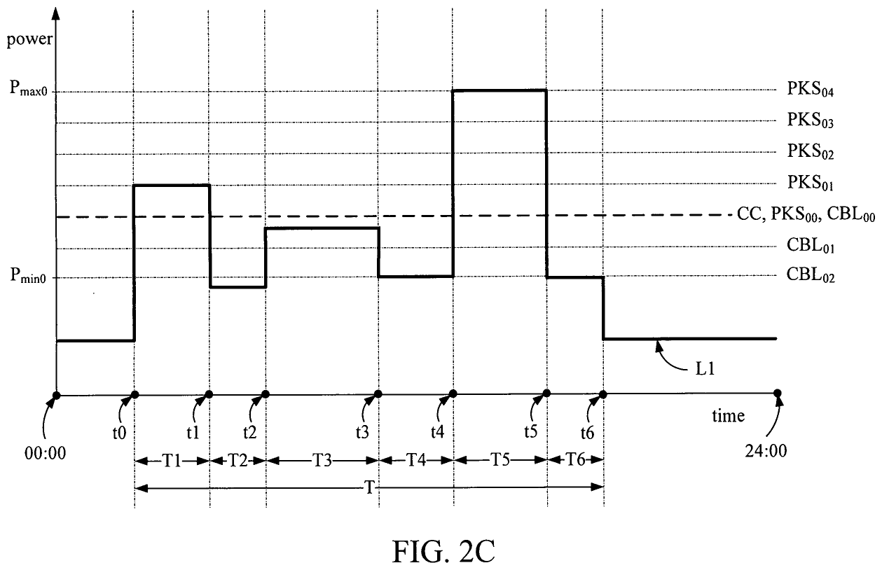

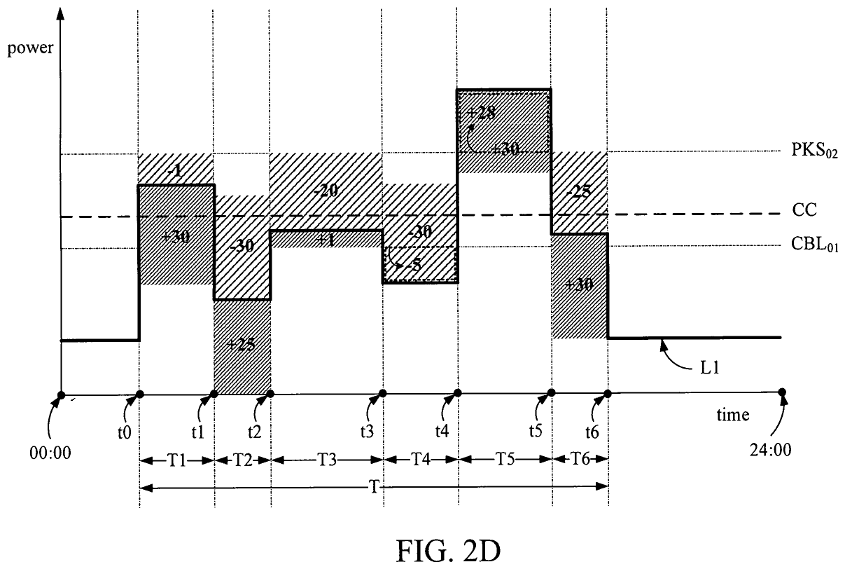

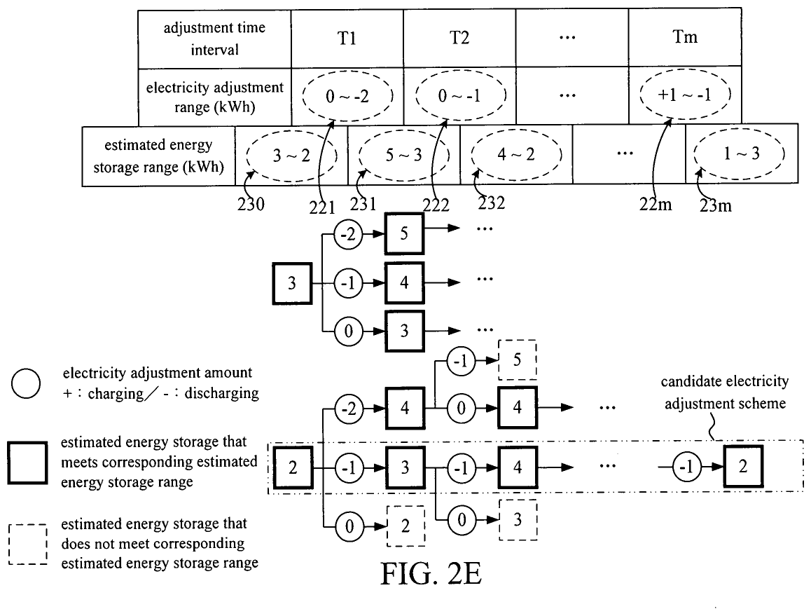

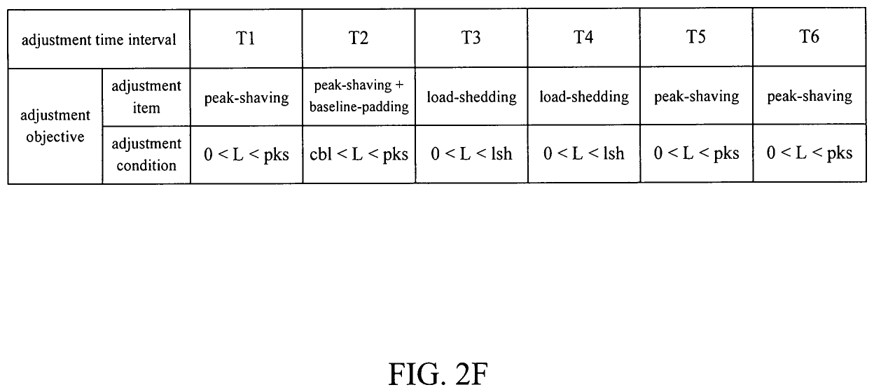

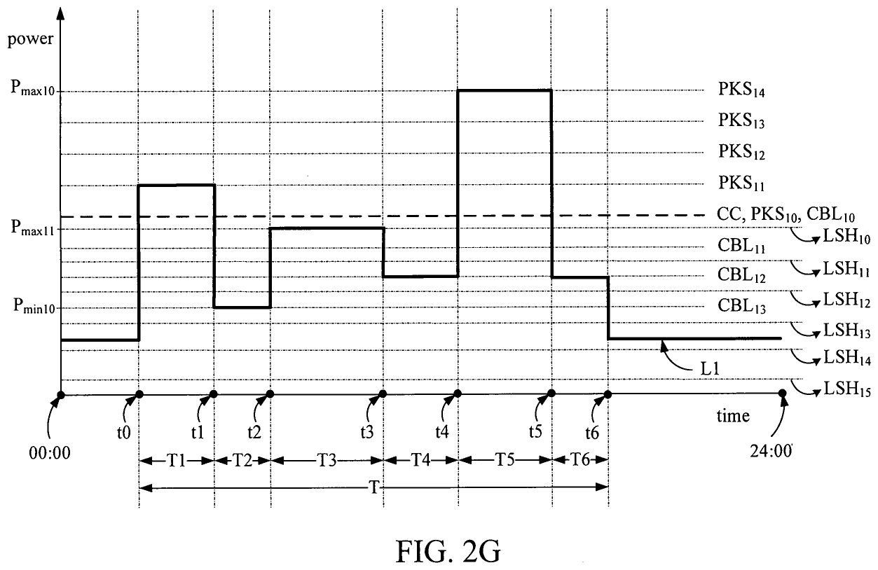

Please refer to FIG. 2A. In the present embodiment, the charge and discharge control apparatus 11 determines an objective electricity adjustment scheme that can be achieved by the energy storage system 15 according to a load prediction curve L1 of the electric loop 13 (that is, the prediction of the electricity consumption of the electronic devices 19a, . . . , 19b connected by the electric loop 13, and the prediction does not take the electricity consumption of the energy storage system 15 into consideration). Generally speaking, the processing unit 113 determines a plurality of adjustment time intervals T1˜T6 of the load prediction curve L1, wherein each of the adjustment time intervals T1˜T6 individually corresponds to an adjustment objective. Next, the processing unit 113 determines a plurality of candidate threshold sets (will be detailed later) according to the adjustment objectives corresponding to the adjustment time intervals T1˜T6 and a charge and discharge requirement of the energy storage system 15. It should be noted that each candidate threshold set corresponds to at least one candidate electricity adjustment scheme. The content of each of the at least one candidate electricity adjustment scheme may include setting a certain (or some) adjustment time interval as charging time interval(s) as well as setting the charging power value for charging the energy storage system 15 in each charging time interval, and/or setting a certain (or some) adjustment time interval as discharging time interval(s) as well as setting the discharging power value for the energy storage system 15 to discharge (i.e. release electricity) in each discharging time interval. The processing unit 113 further determines an objective electricity adjustment scheme of the electric loop 13 from these candidate electricity adjustment schemes.

Thereafter, the energy storage system 15 can adjust the electricity consumption of the electric loop 13 in each of the adjustment time intervals T1˜T6 according to the objective electricity adjustment scheme (for example, the processing unit 113 of the charge and discharge control apparatus 11 may control charge and discharge of the energy storage system 15 via the interface 111 according to the objective electricity adjustment scheme). Since the charge and discharge control apparatus 11 comprehensively considers the charge and discharge conditions of the energy storage system 15 and the adjustment objectives of the respective adjustment time interval T1˜T6 during the process of determining the objective electricity adjustment scheme, the determined objective electricity adjustment scheme can be achieved by charging and discharging the energy storage system 15, and the adjustment objectives of different adjustment time intervals can also be achieved (i.e., multiple objectives can be achieved).

In the following description, the operations performed by the charge and discharge control apparatus 11 will be described in detail. Please refer to FIG. 2A to FIG. 2E together, which illustrate several specific examples for explaining how the charge and discharge control apparatus of the first embodiment determines the objective electricity adjustment scheme. It should be understood that the contents of FIG. 2A to FIG. 2E are only for illustration and are not intended to limit the scope of the invention.

FIG. 2A depicts a schematic diagram of the load prediction curve L1 of the electric loop 13 on a certain power supply day and the adjustment time intervals T1, T2, T3, T4, T5, and T6 determined by the charge and discharge control apparatus 11 according to the load prediction curve L1, where the horizontal axis represents time and the vertical axis represents power. In this specific example, the processing unit 113 refers to a peak electricity consumption time interval (“peak time interval” for short) T provided by the electric power company. The processing unit 113 determines a plurality of turning time points t0, t1, t2, t3, t4, t5, and t6 of the load prediction curve L1 in the peak time interval T, and determines adjustment time intervals T1, T2, T3, T4, T5, and T6 according to these time points t0, t1, t2, t3, t4, t5, and t6. These adjustment time intervals T1, T2, T3, T4, T5, and T6 do not overlap with each other. In some embodiments, the lengths of the adjustment time intervals T1, T2, T3, T4, T5, and T6 may each be a multiple of 15 minutes.

Those skilled in the art should understand that the load prediction curve L1 includes the predicted power consumption corresponding to the plurality of time intervals. Besides, those skilled in the art should understand that there are various techniques for calculating the load prediction curve L1. However, how to calculate the load prediction curve L1 is not the core of the present invention and, therefore, it will not be described herein. It should further be noted that in the specific example shown in FIG. 2A, the processing unit 113 determines the adjustment time intervals T1, T2, T3, T4, T5, and T6 of the load prediction curve L1 based on the peak time interval T of a power supply day, so all of the adjustment time intervals T1, T2, T3, T4, T5, and T6 fall into the peak time interval T. However, in other embodiments, the processing unit 113 may determine the adjustment time intervals of the load prediction curve L1 without considering the peak time interval T (e.g., dividing the entire time interval covered by the load prediction curve L1 into a plurality of adjustment time intervals). Furthermore, the number of adjustment time intervals shown in FIG. 2A is only for illustration and are not intended to limit the scope of the invention.

In the present embodiment, each of the adjustment time intervals T1, T2, T3, T4, T5, and T6 corresponds to an adjustment objective. For example, the adjustment objective of each of the adjustment time intervals T1, T2, T3, T4, T5, and T6 may be set by a consumer according to his/her management requirement for electric load. The adjustment objective of each of the adjustment time intervals T1, T2, T3, T4, T5, and T6 includes at least one of the following adjustment conditions: (a) in the adjustment time interval corresponding to the adjustment objective, having an adjusted load of the electric loop being not greater than a first threshold; and (b) in the adjustment time interval corresponding to the adjustment objective, having the adjusted load of the electric loop being not less than a second threshold.

To be more specific, each adjustment objective may include one or a combination of the following adjustment items: “peak-shaving,” “baseline-padding,” and “load-shedding.” If the adjustment objective corresponding to an adjustment time interval includes the adjustment item “peak-shaving” (It means that the power consumption within the adjustment time interval should be maintained or reduced so that the adjusted load L is not greater than a specific value in order to reduce the demand charge of the consumer), the corresponding adjustment condition will include the above adjustment condition (a) and the first threshold may be a peak-shaving threshold pks, a contracted capacity CC, or other values (depending on the extent of the requirement for “peak-shaving”). If the adjustment objective corresponding to an adjustment time interval includes the adjustment item “baseline-padding” (It means that the power consumption within the adjustment time interval should be maintained or increased so that the adjusted load L is not less than a specific value. In some embodiments, the customer baseline load used by the electric power company for calculating the load reduction amount of demand-response can be increased by setting the adjustment item of the adjustment time interval to “baseline-padding”), the corresponding adjustment condition will include the above adjustment condition (b) and the second threshold may be a baseline-padding threshold cbl, a contracted capacity CC, a value “0,” or other values (depending on the extent of the requirement for “baseline-padding”). If the adjustment objective corresponding to an adjustment time interval includes the adjustment item “load-shedding” (It means that the power consumption within the adjustment time interval should be maintained or reduced so that the adjusted load L is not greater than a specific value. In some embodiments, the load reduction amount of demand-response can be increased by setting the adjustment item of the adjustment time interval to “load-shedding” and thereby obtain more rewards from load reduction amount of demand-response), the corresponding adjustment condition will include the above adjustment condition (a) and the first threshold may be a load-shedding threshold.

In addition to the above adjustment condition (a) and adjustment condition (b), the adjustment objective also requires the adjusted load L of the electric loop 13 to meet the basic conditions. For example, the adjusted load L of the electric loop 13 within all adjustment time intervals cannot be less than “0.”

For ease of understanding, please refer to the specific example illustrated in FIG. 2B. FIG. 2B depicts a schematic diagram of the adjustment time intervals T1˜T6 determined by the processing unit 113 according to the load prediction curve L1, the adjustment objective and the electricity adjustment amount (which will be detailed later) of each of the adjustment time intervals T1˜T6, and the estimated energy storage ranges (which will be detailed later) corresponding to each time point. In this specific example, the adjustment objective of each the adjustment time intervals T1, T2, T5, and T6 include the adjustment item “peak-shaving.” When the basic conditions are taken into consideration as well, the adjustment condition of each of the adjustment time intervals T1, T2, T5, and T6 is the adjusted load L of the electric loop 13 in the corresponding adjustment time intervals T1, T2, T5, and T6 being not less than “0” and not greater than the peak-shaving threshold pks (labeled as “0<L<pks”). In this specific example, the adjustment objective of the adjustment time intervals T3 and T4 include the adjustment items “peak-shaving” and “baseline-padding.” When the basic conditions are taken into consideration together, the adjustment condition of each of the adjustment time intervals T3 and T4 is the adjusted load L of the electric loop 13 in the corresponding adjustment time intervals T3, T4 being not less than the baseline-padding threshold cbl and not greater than the peak-shaving threshold pks (labeled as “cbl<L<pks”).

Please refer to another specific example illustrated in FIG. 2F. In this specific example, the adjustment objective of each of the adjustment time intervals T1, T5, and T6 only includes the adjustment item “peak-shaving.” When the basic conditions are taken into consideration together, the adjustment condition of each of the adjustment time intervals T1, T5, and T6 is the adjusted load L of the electric loop 13 in the corresponding adjustment time intervals T1, T5, and T6 being not less than “0” and not greater than the peak-shaving threshold pks (labeled as “0<L<pks”). In this specific example, the adjustment objective corresponding to the adjustment time interval T2 includes the adjustment items “peak-shaving” and “baseline-padding.” When the basic conditions are taken into consideration together, the adjustment condition corresponding to the adjustment time interval T2 is the adjusted load L of the electric loop 13 in the corresponding adjustment time interval T2 being not less than the baseline-padding threshold cbl and not greater than the peak-shaving threshold pks (labeled as “cbl<L<pks”). In this specific example, the adjustment objective of each of the adjustment time intervals T3, T4 only includes the adjustment item “load-shedding.” When the basic conditions are taken into consideration together, the adjustment condition of each of the adjustment time intervals T3 and T4 is the adjusted load L of the electric loop 13 in the corresponding adjustment time intervals T3, T4 being not less than “0” and not greater than the load-shedding threshold lsh (labeled as “0<L<lsh”).

In the present embodiment, the processing unit 113 can determine a plurality of candidate threshold sets from a plurality of preset threshold sets according to the adjustment objectives and the charge and discharge requirement of the energy storage system 15.

The preset threshold set will be explained herein. Please refer to the specific examples shown in FIG. 2B and FIG. 2C. The processing unit 113 may determine a plurality of candidate peak-shaving thresholds PKS₀₀, PKS₀₁, PKS₀₂, PKS₀₃, and PKS₀₄ between the contracted capacity CC and a peak value Pₘₐₓ₀ of the load prediction curve L1 of the electric loop 13. The peak value Pₘₐₓ₀ may be the maximum value of the load prediction curve L1 in the adjustment time interval(s) which includes the adjustment item “peak-shaving” (in the specific example shown in FIG. 2C, including the adjustment time intervals T1˜T6). In addition, the processing unit 113 may determine a plurality of baseline-padding thresholds CBL₀₀, CBL₀₁, and CBL₀₂ between the contracted capacity CC and a valley value Pₘᵢₙ₀ of the load prediction curve L1 of the electric loop 13. The valley value Pₘᵢₙ₀ may be the minimum value of the load prediction curve L1 in the adjustment time interval(s) which includes the adjustment item “baseline-padding” (in the specific example shown in FIG. 2C, including the adjustment time intervals T3 and T4). It should be noted that the number and value of the candidate peak-shaving threshold and the candidate baseline-padding threshold are only for illustration and are not intended to limit the scope of the invention.

The preset threshold set is further illustrated by another specific example shown in FIG. 2F and FIG. 2G. In this specific example, the processing unit 113 may determine a plurality of candidate peak-shaving thresholds PKS₁₀, PKS₁₁, PKS₁₂, PKS₁₃, and PKS₁₄ between the contracted capacity CC and a peak value Pₘₐₓ₁₀ of the load prediction curve L1 of the electric loop 13. The peak value Pₘₐₓ₁₀ may be the maximum value of the load prediction curve L1 in the adjustment time intervals which include the adjustment item “peak-shaving” (in the specific example shown in FIG. 2G, including the adjustment time intervals T1, T2, T5, and T6). Besides, the processing unit 113 may determine a plurality of baseline-padding thresholds CBL₁₀, CBL₁₁, CBL₁₂, and CBL₁₃ between the contracted capacity CC and a valley value Pₘᵢₙ₁₀ of the load prediction curve L1 of the electric loop 13. The valley value Pₘᵢₙ₁₀ may be the minimum value of the load prediction curve L1 in the adjustment time interval which includes the adjustment item “baseline-padding” (in the specific example shown in FIG. 2G, including the adjustment time interval T2). Furthermore, the processing unit 113 may determine a plurality of candidate load-shedding thresholds LSH₁₀, LSH₁₁, LSH₁₂, LSH₁₃, and LSH₁₄ between the value “0” and a peak value Pₘₐₓ₁₁ of the load prediction curve L1 of the electric loop 13. The peak value Pₘₐₓ₁₁ may be the maximum value of the load prediction curve L1 in the adjustment time intervals which includes the adjustment item “load-shedding” (in the specific example shown in FIG. 2G, including the adjustment time intervals T3 and T4). It should be noted that the numbers and values of the candidate peak-shaving thresholds, the candidate baseline-padding thresholds, and the candidate load-shedding thresholds are only for illustration and are not intended to limit the scope of the invention.

Different implementations may use different kinds of threshold to form the preset threshold sets. In some embodiments, the processing unit 113 may use a candidate peak-shaving threshold, a candidate baseline-padding threshold, and a candidate load-shedding threshold to form a preset threshold set. In some embodiments, the processing unit 113 may use a candidate peak-shaving threshold and a candidate baseline-padding threshold to form a preset threshold set. In the specific example shown in FIG. 2C, if the preset threshold set is formed by a candidate peak-shaving threshold and a candidate baseline-padding threshold, 15 preset threshold sets can be formed at most. In the specific example shown in FIG. 2G, if the preset threshold set is formed by a candidate peak-shaving threshold, a candidate baseline-padding threshold, and a candidate load-shedding threshold, 120 preset threshold sets can be formed at most.

Next, with reference to FIG. 2B and FIG. 2D, the operations performed by the processing unit 113 for each of the preset threshold sets to determine whether each preset threshold set can be used as a candidate threshold set. By these operations, the processing unit 113 determines a plurality of candidate threshold sets from the preset threshold sets are described.

The preset threshold set shown in FIG. 2D (including the candidate peak-shaving threshold PKS₀₂ and the candidate baseline-padding threshold CBL₀₁) will be used as an example to elaborate how the processing unit 113 determines whether a preset threshold set can be used as a candidate threshold set. For each of the adjustment time intervals T1, T2, T3, T4, T5, and T6, the processing unit 113 determines an electricity adjustment range for the energy storage system 15 to adjust the electricity consumption of the electric loop 13 in the adjustment time interval according to the load prediction curve L1, the adjustment objective corresponding to the adjustment time interval, the charge and discharge requirement of the energy storage system 15, and the preset threshold set (i.e., the candidate peak-shaving threshold PKS₀₂ and the candidate baseline-padding threshold CBL₀₁).

It should be noted that the present invention does not limit the order for determining the electricity adjustment range of the adjustment time intervals T1˜T6 by the processing unit 113. In addition, the energy storage system 15 has at least three charge and discharge requirements. First, when the energy storage system 15 adjusts the electricity consumption of the electric loop 13 in a charging manner, the corresponding charging power is not greater than a maximum charging power of the energy storage system 15. Second, when the energy storage system 15 adjusts the electricity consumption of the electric loop 13 in a discharging manner, the corresponding discharging power is not greater than a maximum discharging power of the energy storage system 15. Third, the energy storage system 15 has an energy storage range, and therefore the charging and discharging for the energy storage system 15 cannot exceed the energy storage range.

In the following description, it is assumed that the energy storage range of the energy storage system 15 is “30˜0 kWh.” Since the electricity that the energy storage system 15 can store is 30 kWh at most, the electricity that the energy storage system 15 can discharge to the electric loop 13 within one adjustment time interval is 30 kWh at most. Similarly, since the electricity that the energy storage system 15 can store is “30 kWh” at most, the electricity that the energy storage system 15 can obtain from the power supply system 17 is 30 kWh at most. It should further be noted that the units of the charging power and the discharging power mentioned in this specification are all kilowatts (kW) unless otherwise specified, and the units of the various electricity adjustment amounts (e.g., the charging or discharging energy storage amount of the energy storage system 15) and the various energy storages (e.g., the estimated energy storage and the present energy storage of the energy storage system 15) mentioned in this specification are all kilowatt-hours (kWh) unless otherwise specified.

Please continue with FIG. 2B and FIG. 2D, wherein the symbol “+” illustrated therein represents that the energy storage system 15 releases electricity to the electric loop 13 to reduce the net electricity consumption of the electric loop 13 on the power supply system 17 (i.e., to reduce the load of the electric loop 13), and the symbol “−” illustrated therein represents that the net electricity consumption of the electric loop 13 on the power supply system 17 is increased by charging the energy storage system 15 (i.e., to increase the load of the electric loop 13). The net electricity consumption of the electric loop 13 is the amount of the power supplied by the power supply system 17 to the electric loop 13 as illustrated in FIG. 1. In the specific examples shown in FIG. 2B and FIG. 2D, the processing unit 113 evaluates whether the preset threshold set formed by the candidate peak-shaving threshold PKS₀₂ and the candidate baseline-padding threshold CBL₀₁ can be used as a candidate threshold set, and therefore the peak-shaving threshold pks and the baseline-padding threshold cbl of the adjustment conditions shown in FIG. 2B are the candidate peak-shaving threshold PKS₀₂ and the baseline-padding threshold CBL₀₁ respectively.

For the adjustment time interval T1, the processing unit 113 determines an electricity adjustment range for the energy storage system 15 to adjust the electricity consumption of the electric loop 13 in the adjustment time interval T1 according to the predicted power consumption of the load prediction curve L1 within the adjustment time interval T1, the corresponding adjustment objective (which includes the adjustment item “peak-shaving,” and the corresponding adjustment condition is “0<L<pks”), the charge and discharge requirement of the energy storage system 15, and the preset threshold set (i.e., the candidate peak-shaving threshold PKS₀₂ and the candidate baseline-padding threshold CBL₀₁). As shown in FIG. 2D, the predicted power consumption of the load prediction curve L1 within the adjustment time interval T1 is between the value “0” and the candidate peak-shaving threshold PKS₀₂. If it is going to charge the energy storage system 15 in the adjustment time interval T1, the energy storage system 15 can be charged “1 kWh” at most (i.e., the area labeled as “−1” in the adjustment time interval T1 in FIG. 2D) with the consideration of the charge and discharge requirement of the energy storage system 15 and the corresponding adjustment objective. If it is going to discharge the energy storage system 15 in the adjustment time interval T1, the energy storage system 15 can be discharged “30 kWh” at most (i.e., the area labeled as “+30” in the adjustment time interval T1 in FIG. 2D) with the consideration of the charge and discharge requirement of the energy storage system 15 and the corresponding adjustment objective. Therefore, the allowed electricity adjustment range for the energy storage system 15 to adjust the electricity consumption of the electric loop 13 within the adjustment time interval T1 is “+30˜−1 kWh.”

For the adjustment time interval T2, the processing unit 113 determines an electricity adjustment range for the energy storage system 15 to adjust the electricity consumption of the electric loop 13 in the adjustment time interval T2 according to the predicted power consumption of the load prediction curve L1 within the adjustment time interval T2, the corresponding adjustment objective (which includes the adjustment item “peak-shaving,” and the corresponding adjustment condition is “0<L<pks”), the charge and discharge requirement of the energy storage system 15, and the preset threshold set (i.e., the candidate peak-shaving threshold PKS₀₂ and the candidate baseline-padding threshold CBL₀₁). As shown in FIG. 2D, the predicted power consumption of the load prediction curve L1 within the adjustment time interval T2 is between the value “0” and the candidate peak-shaving threshold PKS₀₂. If it is going to charge the energy storage system 15 in the adjustment time interval T2, the energy storage system 15 can be charged “30 kWh” at most (i.e., the area labeled as “−30” in the adjustment time interval T2 in FIG. 2D) with the consideration of the charge and discharge requirement of the energy storage system 15 and the corresponding adjustment objective. If it is going to discharge the energy storage system 15 in the adjustment time interval T2, the energy storage system 15 can be discharged “25 kWh” at most (i.e., the area labeled as “+25” in the adjustment time interval T2 in FIG. 2D) with the consideration of the charge and discharge requirement of the energy storage system 15 and the corresponding adjustment objective. Therefore, the allowed electricity adjustment range for the energy storage system 15 to adjust the electricity consumption of the electric loop 13 within the adjustment time interval T2 is “+25˜−30 kWh.”

For the adjustment time interval T3, the processing unit 113 determines an electricity adjustment range for the energy storage system 15 to adjust the electricity consumption of the electric loop 13 in the adjustment time interval T3 according to the predicted power consumption of the load prediction curve L1 within the adjustment time interval T3, the corresponding adjustment objective (which includes the adjustment item “peak-shaving” and “baseline-padding,” and the corresponding adjustment condition is “cbl<L<pks”), the charge and discharge requirement of the energy storage system 15, and the preset threshold set (i.e., the candidate peak-shaving threshold PKS₀₂ and the candidate baseline-padding threshold CBL₀₁). As shown in FIG. 2D, the predicted power consumption of the load prediction curve L1 within the adjustment time interval T3 is between the candidate baseline-padding threshold CBL₀₁ and the candidate peak-shaving threshold PKS₀₂. If it is going to charge the energy storage system 15 in the adjustment time interval T3, the energy storage system 15 can be charged “20 kWh” at most (i.e., the area labeled as “−20” in the adjustment time interval T3 in FIG. 2D) with the consideration of the charge and discharge requirement of the energy storage system 15 and the corresponding adjustment objective. If it is going to discharge the energy storage system 15 in the adjustment time interval T3, the energy storage system 15 can be discharged “1 kWh” at most (i.e., the area labeled as “+1” in the adjustment time interval T3 in FIG. 2D) with the consideration of the charge and discharge requirement of the energy storage system 15 and the corresponding adjustment objective. Therefore, the allowed electricity adjustment range for the energy storage system 15 to adjust the electricity consumption of the electric loop 13 within the adjustment time interval T3 will be “+1˜−20 kWh.”

For the adjustment time interval T4, the processing unit 113 determines an electricity adjustment range for the energy storage system 15 to adjust the electricity consumption of the electric loop 13 in the adjustment time interval T4 according to the predicted power consumption of the load prediction curve L1 within the adjustment time interval T4, the corresponding adjustment objective (which includes the adjustment item “peak-shaving” and “baseline-padding,” and the corresponding adjustment condition is “cbl<L<pks”), the charge and discharge requirement of the energy storage system 15, and the preset threshold set (i.e., the candidate peak-shaving threshold PKS₀₂ and the candidate baseline-padding threshold CBL₀₁). As shown in FIG. 2D, the predicted power consumption of the load prediction curve L1 within the adjustment time interval T4 is between the value “0” and the candidate baseline-padding threshold CBL₀₁ (i.e., lower than the candidate baseline-padding threshold CBL₀₁). Therefore, in the adjustment time interval T4, the energy storage system 15 cannot be discharged but has to be charged. With the consideration of the charge and discharge requirement of the energy storage system 15 and the corresponding adjustment objective, the energy storage system 15 can be charged “30 kWh” at most (i.e., the area labeled as “−30” in the adjustment time interval T4 in FIG. 2D) and the energy storage system 15 has to be charged “5 kWh” at least (i.e., the area labeled as “−5” in the adjustment time interval T4 in FIG. 2D) in order to make the adjusted load be greater than the candidate baseline-padding threshold CBL₀₁. Therefore, the allowed electricity adjustment range for the energy storage system 15 to adjust the electricity consumption of the electric loop 13 within the adjustment time interval T4 is “−5˜−30 kWh.”

For the adjustment time interval T5, the processing unit 113 determines an electricity adjustment range for the energy storage system 15 to adjust the electricity consumption of the electric loop 13 in the adjustment time interval T5 according to the predicted power consumption of the load prediction curve L1 within the adjustment time interval T5, the corresponding adjustment objective (which includes the adjustment item “peak-shaving,” and the corresponding adjustment condition is “0<L<pks”), the charge and discharge requirement of the energy storage system 15, and the preset threshold set (i.e., the candidate peak-shaving threshold PKS₀₂ and the candidate baseline-padding threshold CBL₀₁). As shown in FIG. 2D, the predicted power consumption of the load prediction curve L1 within the adjustment time interval T5 is greater than the candidate peak-shaving threshold PKS₀₂. Therefore, in the adjustment time interval T5, the energy storage system 15 cannot be charged and has to be discharged. With the consideration of the charge and discharge requirement of the energy storage system 15 and the corresponding adjustment objective, the energy storage system 15 can be discharged “30 kWh” at most (i.e., the area labeled as “+30” in the adjustment time interval T5 in FIG. 2D) and the energy storage system 15 has to be discharged “28 kWh” at least (i.e., the area labeled as “+28” in the adjustment time interval T5 in FIG. 2D) to make the adjusted load be not greater than the candidate peak-shaving threshold PKS₀₂. Therefore, the allowed electricity adjustment range for the energy storage system 15 to adjust the electricity consumption of the electric loop 13 within the adjustment time interval T5 is “+30˜+28 kWh.”

For the adjustment time interval T6, the processing unit 113 determines an electricity adjustment range for the energy storage system 15 to adjust the electricity consumption of the electric loop 13 in the adjustment time interval T6 according to the predicted power consumption of the load prediction curve L1 within the adjustment time interval T6, the corresponding adjustment objective (which includes the adjustment item “peak-shaving,” and the corresponding adjustment condition is “0<L<pks”), the charge and discharge requirement of the energy storage system 15, and the preset threshold set (i.e., the candidate peak-shaving threshold PKS₀₂ and the candidate baseline-padding threshold CBL₀₁). As shown in FIG. 2D, the predicted power consumption of the load prediction curve L1 within the adjustment time interval T6 is between the value “0” and the candidate peak-shaving threshold PKS₀₂. Similarly, if it is going to charge the energy storage system 15 in the adjustment time interval T6, the energy storage system 15 can be charged “25 kWh” at most (i.e., the area labeled as “−25” in the adjustment time interval T6 in FIG. 2D). If it is going to discharge the energy storage system 15 in the adjustment time interval T6, the energy storage system 15 can be discharged “30 kWh” at most (i.e., the area labeled as “+30” in the adjustment time interval T6 in FIG. 2D). Therefore, the allowed electricity adjustment range for the energy storage system 15 to adjust the electricity consumption of the electric loop 13 within the adjustment time interval T6 is “+30˜−25 kWh.”

After the processing unit 113 determines the electricity adjustment ranges of all the adjustment time intervals T1˜T6, the processing unit 113 calculates an estimated energy storage range at the start-time point of each of the adjustment time intervals T1˜T6 based on an estimated energy storage range at the end-time point (i.e., the time point t6) of the last one of the adjustment time intervals (i.e., the adjustment time interval T6) and the electricity adjustment range of each of the adjustment time intervals T1˜T6 by following a reverse order (i.e., from the adjustment time interval T6 to the adjustment time interval T1) of the sequence (i.e., from the adjustment time interval T1 to the adjustment time interval T6) of the adjustment time intervals T1˜T6. It should be noted that each of the adjustment time intervals T1˜T6 has a start-time point and an end-time point. The start-time point of each adjustment time interval is the end-time point of the previous adjustment time interval except for the first one (i.e., the adjustment time interval T1) of the adjustment time intervals T1˜T6. For example, the start-time point (i.e., the time point t3) of the adjustment time interval T4 is the end-time point (i.e., the time point t3) of its previous adjustment time interval (i.e., the adjustment time interval T3).

As previously mentioned, the energy storage system 15 has an energy storage range. Therefore, the present energy storage of the energy storage system 15 in any adjustment time interval has to fall into the energy storage range. In the present embodiment, since the energy storage range of the energy storage system 15 is “30˜0 kWh,” the upper threshold of the energy storage range is “30 kWh” and the lower threshold of the energy storage range is “0 kWh.”

In the present embodiment, the estimated energy storage range at the end-time point t6 of the adjustment time interval T6 may be preset to “30˜0 kW” (labeled as the estimated energy storage range 216 in FIG. 2B), which represents that the present energy storage of the energy storage system 15 at the time point t6 can fall in the range of “30˜0 kWh.”

Next, for each of the adjustment time intervals T6˜T1, the processing unit 113 calculates the estimated energy storage range at the start-time point of the adjustment time interval according to the estimated energy storage range of the energy storage system 15 at the end-time point of the adjustment time interval, the electricity adjustment range of the adjustment time interval, and the upper threshold and the lower threshold of the energy storage range. Specifically, for the adjustment time interval T6, the processing unit 113 obtains the estimated energy storage range (see the estimated energy storage range 215 illustrated in FIG. 2B) of the start-time point (i.e., the time point t5) of the adjustment time interval T6 by adding the electricity adjustment range “+30˜−25 kWh” (see the electricity adjustment range 206 illustrated in FIG. 2B) of the adjustment time interval T6 to the estimated energy storage range “+30˜0 kWh” (see the estimated energy storage range 216 illustrated in FIG. 2B) of the end-time point of the adjustment time interval T6 and then excluding the portion of the energy storage amount that is above the upper threshold (i.e., greater than “30 kWh”) and the portion of the energy storage amount that is below the lower threshold (i.e., lower than “0 kWh”). This also means that the estimated energy storage range of the end-time point (i.e., the time point t5) of the adjustment time interval T5 has been calculated.

Similarly, the processing unit 113 obtains the estimated energy storage range “30˜28 kWh” (see the estimated energy storage range 214 illustrated in FIG. 2B) of the start-time point (i.e., the time point t4) of the adjustment time interval T5 by adding the electricity adjustment range “+30˜+28 kWh” (see the electricity adjustment range 205 illustrated in FIG. 2B) of the adjustment time interval T5 to the estimated energy storage range “+30˜0 kWh” of the end-time point of the adjustment time interval T5 and then excluding the portion of the energy storage amount that is above the upper threshold and the portion of the energy storage amount that is below the lower threshold. Likewise, the processing unit 113 then performs similar operations to calculate the estimated energy storage range of the start-time point of each of the remaining adjustment time intervals T4, T3, T2, and T1 in the reverse order of the sequence.

If the processing unit 113 determines that all the estimated energy storage ranges (i.e., the estimated energy storage ranges of all the adjustment time intervals T1˜T6) corresponding to the preset threshold set that is currently evaluated (e.g., the preset threshold set formed by the candidate peak-shaving threshold PKS₀₂ and the candidate baseline-padding threshold CBL₀₁) fall into the energy storage range of the energy storage system 15, the processing unit 113 determines that the preset threshold set is a candidate threshold set. In other words, if the processing unit 113 observes, during the process of calculating the estimated energy storage ranges of the start-time point of the adjustment time intervals T6˜T1, that an start-time point of an adjustment time interval does not have an estimated energy storage range within the energy storage range, the processing unit 113 precludes the preset threshold set from being a candidate threshold set.

After the processing unit 113 performs the above operations for each preset threshold set, the candidate threshold sets can be determined. Each candidate threshold set determined by the processing unit 113 corresponds to at least one candidate electricity adjustment scheme, which means that each candidate threshold set has at least one feasible electricity adjustment scheme. The processing unit 113 further determines an objective electricity adjustment scheme from the candidate electricity adjustment schemes so that the energy storage system 15 adjusts the electricity consumption of the electric loop 13 according to the objective electricity adjustment scheme in each of the adjustment time interval T1˜T6 individually.

It should be noted that the specific example shown in FIG. 2B and FIG. 2D is referred to in the above description for explaining how the processing unit 113 determines a plurality of candidate threshold sets from the preset threshold sets in the case that the adjustment objective includes the adjustment items “peak-shaving” and “baseline-padding.” In some cases, the adjustment objective may include the adjustment items “load-shedding” besides the adjustment items “peak-shaving” and “baseline-padding.” If the adjustment objective includes the adjustment items “peak-shaving,” “baseline-padding,” and “load-shedding,” (e.g., the specific example shown in FIG. 2F and FIG. 2G), the processing unit 113 can operate the similar operations to determine a plurality of candidate threshold sets from a plurality of preset threshold sets since the objective of the adjustment objective “load-shedding” is similar to the objective of the adjustment objective “peak-shaving” (both of them are to maintain or reduce the power consumption in an adjustment time interval so that the adjusted load L will be lower than a specific value). According to the above description, those skilled in the art will understand the operations that have to be performed by the processing unit 113 for the case that the adjustment objective includes the adjustment items “peak-shaving,” baseline-padding,” and “load-shedding,” and therefore it will not be described herein.

The present invention provides two alternative ways to determine the objective electricity adjustment scheme. In the first way, the processing unit 113 calculates an adjustment benefit indicator for each of the candidate electricity adjustment schemes and then determines the objective electricity adjustment scheme from the candidate electricity adjustment schemes according to the adjustment benefit indicators. For example, the above adjustment benefit indicator may be related to the expected reduced electricity charges (e.g. the reduced TOU charges, the reduced charges regarding the contracted capacity, the increased rewards for load reduction of demand-response) and the caused adjustment charges (e.g. the number of times for charging and discharging and the depreciation expense thereof) after adjusting the electricity consumption of the electric loop 13 by adopting a candidate electricity adjustment scheme.

In the second way, the processing unit 113 calculates a set indicator for each candidate threshold set, determines an objective threshold set from the candidate threshold sets based on the set indicators, generates an adjustment benefit indicator for each of the at least one candidate electricity adjustment schemes corresponding to the objective threshold set, and then determines the objective electricity adjustment scheme from the at least one candidate electricity adjustment scheme of the objective threshold set according to the adjustment benefit indicator(s). For example, a set indicator of a candidate threshold set may be related to the expected reduced charges (e.g. the reduced TOU charges, the reduced charges regarding the contracted capacity, the increased rewards for load reduction of demand-response) of the general result of adjusting power consumption according to the candidate threshold set (i.e., making the power consumption of the adjustment time intervals not greater than the candidate peak-shaving threshold when the adjustment objective of the adjustment time intervals includes the adjustment item “peak-shaving,” making the power consumption of the adjustment time intervals not smaller than the candidate baseline-padding threshold when the adjustment objective of the adjustment time intervals includes the adjustment item “baseline-padding,” and making the power consumption of the adjustment time intervals not greater than the candidate load-shedding threshold when the adjustment objective of the adjustment time intervals includes the adjustment item “load-shedding”).

If the first way is adopted, the processing unit 113 calculates an adjustment benefit indicator for each of all candidate electricity adjustment schemes, and then determines the objective electricity adjustment scheme from the candidate electricity adjustment schemes according to the adjustment benefit indicators. Therefore, the processing unit 113 can find the most effective electricity adjustment scheme (for example, reducing most electricity charge, causing minimum adjustment charges, or the combination of the two), that is, finding the best electricity adjustment scheme. If the second way is adopted, the processing unit 113 only needs to calculate the adjustment benefit indicator for each candidate electricity adjustment scheme corresponding to the objective threshold set, and does not need to calculate the adjustment benefit indicator for each candidate electricity adjustment scheme corresponding to other objective threshold set, and therefore the operations that have to be performed are reduced and the operation time is shortened.

Next, with reference to FIG. 2E, the details regarding how the processing unit 113 generates the at least one candidate electricity adjustment scheme corresponding to a candidate threshold set will be described. In the specific example shown in FIG. 2E, regarding a certain candidate threshold set, the processing unit 113 has calculated the electricity adjustment ranges 221, 222, . . . , 22m of the adjustment time intervals T1, T2, . . . , Tm respectively, the estimated energy storage ranges 230, 231, 232, . . . of the start-time point of the adjustment time intervals T1, T2, . . . , Tm respectively, and the estimated energy storage range 23m of the end-time point of the adjustment time interval Tm.

Next, the processing unit 113 determines an initial energy storage for the start-time point of the first adjustment time interval T1, and uses this initial energy storage as an estimated energy storage of the start-time point of the adjustment time interval T1. In some implementations, the processing unit 113 may determine the initial energy storage from a predetermined initial energy storage range. Thereafter, the processing unit 113 determines the corresponding candidate electricity adjustment schemes according to the initial energy storage of the adjustment time interval T1, the electricity adjustment range of each adjustment time interval T1, T2, Tm, and the estimated energy storage range of the start-time point of each adjustment time intervals T1, T2, Tm. In brief, for a candidate threshold set, the processing unit 113 may at least once perform the following operations to each of the adjustment time intervals T1, T2, Tm according to a sequence of the adjustment time intervals T1, T2, Tm: determining an electricity adjustment amount within the electricity adjustment range corresponding to the adjustment time interval and the candidate threshold set so that an estimated energy storage of the energy storage system at the start-point of the adjustment time interval after being adjusted according to the electricity adjustment amount falls into the estimated energy storage range at the start-time point of a next adjustment time interval according to the sequence.

For ease of understanding, the example shown in FIG. 2E will be described. In this specific example, the processing unit 113 searches for all the candidate electricity adjustment schemes exhaustively. The processing unit 113 determines an initial energy storage “2 kWh” from the estimated energy storage range (that is, “3˜2 kWh”) corresponding to the start-time point of the first adjustment time interval T1, and use this initial energy storage as an estimated energy storage of the start-time point of the adjustment time interval T1. Next, the processing unit 113 determines at least one electricity adjustment amount from the electricity adjustment range (that is, “0 to −2 kWh”) corresponding to the adjustment time interval T1 so that the estimated energy storage (that is, “2 kWh”) of the energy storage system 15 at the start-point of the adjustment time interval T1 after being adjusted according to the determined electricity adjustment amount falls into the estimated energy storage range (that is, within the range of “5˜3 kWh”) at the start-time point of the next adjustment time interval T2. As shown in FIG. 2E, the electricity adjustment amounts “−2 kWh” and “−1 kWh” of the electricity adjustment range corresponding to the adjustment time interval T1 will respectively make the adjusted estimated energy storage “4 kWh” and “3 kWh” fall into the estimated energy storage range of the start-time point of the adjustment time interval T2.

Next, for the adjustment time interval T2, the processing unit 113 performs similar operations. For the estimated energy storage “4 kWh” at the start-time point of the adjustment time interval T2, the processing unit 113 determines at least one electricity adjustment amount from the electricity adjustment range (that is, “0 to −1 kWh”) corresponding to the adjustment time interval T2 so that the estimated energy storage (that is, “4 kWh”) of the energy storage system 15 at the start-point of the adjustment time interval T2 after being adjusted according to the determined electricity adjustment amount falls into the estimated energy storage range at the start-time point of the next adjustment time interval. Similarly, for the estimated energy storage “3 kWh” at the start-time point of the adjustment time interval T2, the processing unit 113 determines at least one electricity adjustment amount from the electricity adjustment range (that is, “0 to −1 kWh”) corresponding to the adjustment time interval T2 so that the estimated energy storage (that is, “3 kWh”) of the energy storage system 15 at the start-point of the adjustment time interval T2 after being adjusted according to the determined electricity adjustment amount falls into the estimated energy storage range at the start-time point of the next adjustment time interval. The processing unit 113 continues the foregoing operations until the estimated energy storage range 23m of the last adjustment time interval Tm is calculated.

As mentioned above, the example shown in FIG. 2E searches for all the candidate electricity adjustment schemes exhaustively. Therefore, the processing unit 113 will further determine other values as the initial energy storage from the estimated energy storage range (that is, “3˜2 kWh”) corresponding to the start-time point of the first adjustment time interval T1, and perform the above operations again to find out all the candidate electricity adjustment schemes. However, it should be understood that in some embodiments, the processing unit 113 may find the candidate electricity adjustment schemes by other mechanism instead of searching for them exhaustive as long as one or more candidate electricity adjustment schemes can be found.

In the foregoing calculation process, if the processing unit 113 finds a set of electricity adjustment amounts for a certain initial energy storage so that the corresponding electricity adjustment amount of each adjustment time interval and the estimated energy storage of the end-time point of each adjustment time interval meet the estimated energy storage range of the start-time point of the next adjustment time interval, then the processing unit 113 determines the electricity adjustment amounts of the adjustment time intervals as a candidate electricity adjustment scheme.

In summary, the charge and discharge control apparatus 11 provided by the present invention sets a plurality of adjustment time intervals (e.g. the adjustment time interval T1˜T6) for the load prediction curve L1, and each adjustment time interval T1˜T6 can be flexibly set for a corresponding adjustment objective. In the process of determining the objective electricity adjustment scheme, the charge and discharge control apparatus 11 considers the adjustment objectives of all the adjustment time intervals T1˜T6. Thus, the determined objective electricity adjustment scheme not only satisfies the adjustment objective of each adjustment time interval but also enables the energy storage system 15 to effectively achieve load shifting and peak load shaving and thereby reduce the demand charge and the energy charge of the consumer, reduce the overall peak load of the power supply systems of the electric power companies, and even make the consumer obtain more rewards from load reduction of demand-response.

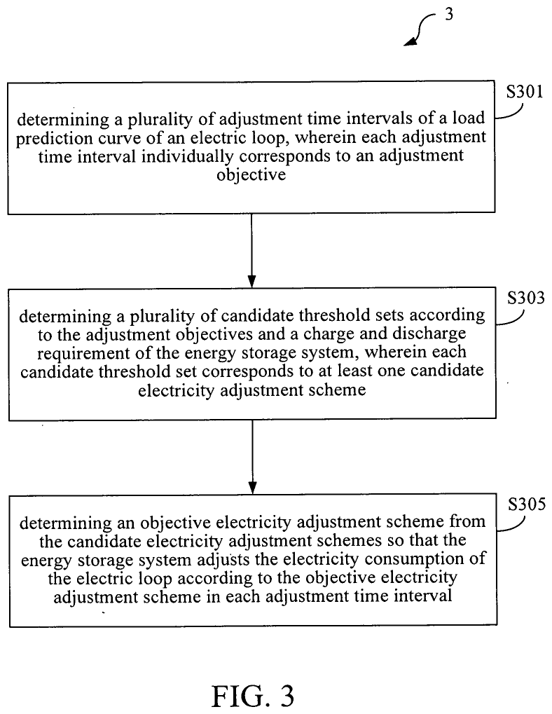

A second embodiment of the present invention is a charge and discharge control method 3, and a flowchart thereof is depicted in FIG. 3. The charge and discharge control method 3 is adapted to an electronic computing apparatus (for example, the charge and discharge control apparatus 11 of the first embodiment), and the electronic computing apparatus is adapted to control an energy storage system. In the following description, the details of the charge and discharge control method 3 will be described.

The charge and discharge control method 3 includes steps S301, S303, and S305. In step S301, the electronic computing apparatus determines a plurality of adjustment time intervals of a load prediction curve of an electric loop, wherein each adjustment time interval individually corresponds to an adjustment objective.

In some embodiments, each adjustment objective may include at least one of the following plurality of adjustment conditions: (a) in the adjustment time interval corresponding to the adjustment objective, having an adjusted load of the electric loop being not greater than a first threshold; and (b) in the adjustment time interval corresponding to the adjustment objective, having the adjusted load of the electric loop being not less than a second threshold. Each first threshold may be one of a candidate peak-shaving threshold, a candidate load-shedding threshold, and a contracted capacity, and each second threshold may be one of a value of “0,” a candidate baseline-padding threshold, and the contracted capacity.

In step S303, the electronic computing apparatus determines a plurality of candidate threshold sets according to the adjustment objectives and a charge and discharge requirement of the energy storage system, wherein each candidate threshold set corresponds to at least one candidate electricity adjustment scheme.

In some embodiments, step S303 determines the candidate threshold sets from a plurality of preset threshold sets. Different implementations may use different kinds of threshold to form the preset threshold set. In some embodiments, the charge and discharge control method 3 may use a candidate peak-shaving threshold, a candidate baseline-padding threshold, and a candidate load-shedding threshold to form a preset threshold set. In some embodiments, the charge and discharge control method 3 may use a candidate peak-shaving threshold and a candidate baseline-padding threshold to form a preset threshold set.

Next, how the candidate threshold sets are determined from the preset threshold sets in step S303 of some embodiments will be described below. Specifically, the adjustment time intervals are in a sequence, each adjustment time interval has a start-time point and an end-time point. The start-time point of each adjustment time interval is the end-time point of the previous adjustment time interval except for the first one of the adjustment time intervals. In step S303, the electronic computing apparatus may perform the following steps (a), (b), and (c) for each of a plurality of preset threshold sets to determine the candidate threshold sets from the preset threshold sets. In step (a), the electronic computing apparatus determines, for each adjustment time interval, an electricity adjustment range for the energy storage system to adjust the electricity consumption of the electric loop in the adjustment time interval according to the load prediction curve, the adjustment objective corresponding to the adjustment time interval, the charge and discharge requirement, and the preset threshold set. In step (b), the electronic computing apparatus calculates, according to a reverse order of the sequence, an estimated energy storage range at the start-time point of each adjustment time interval based on an estimated energy storage range at the end-time point of the last one of the adjustment time intervals and the electricity adjustment range of each adjustment time interval. In step (c), the electronic computing apparatus selects the preset threshold set as one of the candidate threshold sets when determining that all of the estimated energy storage ranges corresponding to the preset threshold set fall into an energy storage range of the energy storage system.

In some embodiments, the aforementioned step (b) may be achieved by the electronic computing apparatus by performing the following step for each of the adjustment time intervals: calculating the estimated energy storage range at the start-time point of the adjustment time interval according to the estimated energy storage range of the energy storage system at the end-time point of the adjustment time interval, the electricity adjustment range, an upper threshold of the energy storage range, and an lower threshold of the energy storage range.

After step S303, the charge and discharge control method 3 performs step S305, in which the electronic computing apparatus determines an objective electricity adjustment scheme from the candidate electricity adjustment schemes so that the energy storage system adjusts the electricity consumption of the electric loop according to the objective electricity adjustment scheme in each adjustment time interval.

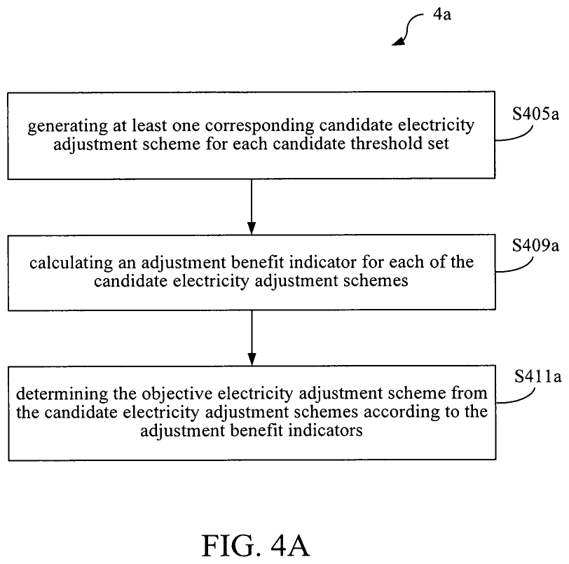

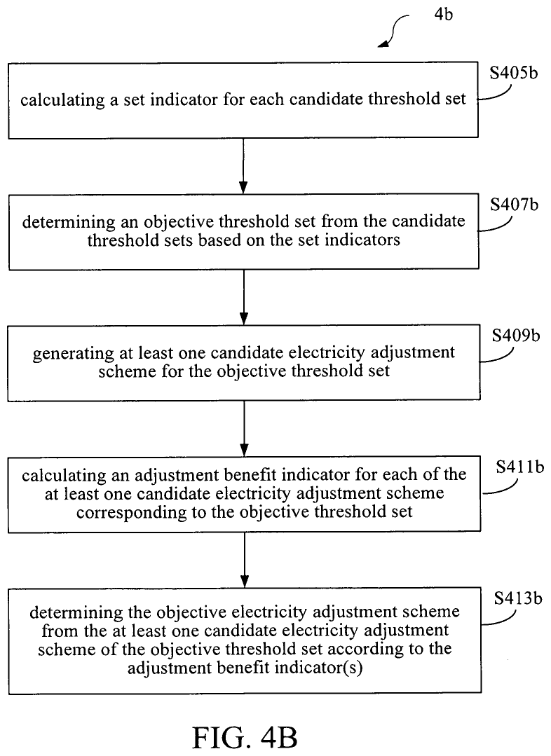

It should be noted that, in some embodiments, the electronic computing apparatus may perform the process 4a illustrated in FIG. 4A to accomplish step S305 and thereby determine the objective electricity adjustment scheme. In detail, the process 4a may include step S405a, step S409a, and step S411a. In step S405a, the electronic computing apparatus generates at least one candidate electricity adjustment scheme for each candidate threshold set. In step S409a, the electronic computing apparatus calculates an adjustment benefit indicator for each of the candidate electricity adjustment schemes. In step S411a, the electronic computing apparatus determines the objective electricity adjustment scheme from the candidate electricity adjustment schemes according to the adjustment benefit indicators.

It should be noted that, in some embodiments, the electronic computing apparatus may perform the process 4b illustrated in FIG. 4B to accomplish step S305 and thereby determine the objective electricity adjustment scheme. In detail, the process 4b may include step S405b, step S407b, step S409b, step S411b, and step S413b. In step S405b, the electronic computing apparatus calculates a set indicator for each candidate threshold set. In step S407b, the electronic computing apparatus determines an objective threshold set from the candidate threshold sets based on the set indicators. In step S409b, the electronic computing apparatus generates at least one candidate electricity adjustment scheme for the objective threshold set. In step S411b, the electronic computing apparatus calculates an adjustment benefit indicator for each of the at least one candidate electricity adjustment scheme corresponding to the objective threshold set. In step S413b, the electronic computing apparatus determines the objective electricity adjustment scheme from the at least one candidate electricity adjustment scheme of the objective threshold set according to the adjustment benefit indicator(s).

It should be noted that, in some embodiments, the charge and discharge control method 3 may make the electronic computing apparatus to perform the following steps for each candidate threshold set at least once to generate the corresponding at least one candidate electricity adjustment scheme: (a) performing the following step for each adjustment time interval according to the sequence: determining an electricity adjustment amount within the electricity adjustment range corresponding to the adjustment time interval and the candidate threshold set so that an estimated energy storage of the energy storage system at the start-point of the adjustment time interval after being adjusted according to the electricity adjustment amount falls into the estimated energy storage range at the start-time point of a next adjustment time interval according to the sequence, and wherein if the adjustment time interval is the first one of the adjustment time intervals, the estimated energy storage of the start-time point of the adjustment time interval is an initial energy storage; and (b) setting the electricity adjustment amounts corresponding to the adjustment time intervals as one of the at least one candidate electricity adjustment scheme. In short, step S405a may perform the foregoing steps for each of the candidate threshold sets to generate the corresponding at least one candidate electricity adjustment scheme. Similarly, step S409b may perform the foregoing steps for the objective threshold set to generate the corresponding at least one candidate electricity adjustment scheme.

In addition to the aforesaid steps, the second embodiment can execute all the operations and steps of the charge and discharge control apparatus 11 set forth in the first embodiment, have the same functions, and deliver the same technical effects as the first embodiment. How the second embodiment executes these operations and steps, has the same functions, and delivers the same technical effects as the first embodiment shall be readily appreciated by those skilled in the art based on the above explanation of the first embodiment, and thus will not be further described herein.

In summary, the charge and discharge control technology (including apparatus and method) provided by the present invention sets a plurality of adjustment time intervals for a load prediction curve, and each adjustment time interval can be flexibly set for a corresponding adjustment objective. In the process of determining the objective electricity adjustment scheme, the charge and discharge control technology provided by the present invention considers the adjustment objectives of different adjustment time intervals. Thus, the determined objective electricity adjustment scheme not only satisfies the adjustment objective of each adjustment time interval but also enables the energy storage system to effectively achieve load shifting and peak load shaving and thereby reduce the demand charge and the energy charge of the consumer, reduce the overall peak load of the power supply systems of the electric power companies, and even make the consumer obtain more rewards from load reduction of demand-response.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A charge and discharge control apparatus, comprising:
an interface, being electrically connected to an energy storage system; and
a processing unit, being electrically connected to the interface and configured to perform the following operations:
determining a plurality of adjustment time intervals of a load prediction curve of an electric loop, wherein each adjustment time interval individually corresponds to an adjustment objective;
determining a plurality of candidate threshold sets according to the adjustment objectives and a charge and discharge requirement of the energy storage system, wherein each candidate threshold set corresponds to at least one candidate electricity adjustment scheme; and
determining an objective electricity adjustment scheme from the candidate electricity adjustment schemes so that the energy storage system adjusts the electricity consumption of the electric loop according to the objective electricity adjustment scheme in each adjustment time interval.

2. The charge and discharge control apparatus of claim 1, wherein each adjustment objective comprises at least one of the following adjustment conditions:
in the adjustment time interval corresponding to the adjustment objective, having an adjusted load of the electric loop being not greater than a first threshold; and
in the adjustment time interval corresponding to the adjustment objective, having the adjusted load of the electric loop being not less than a second threshold.

3. The charge and discharge control apparatus of claim 2, wherein each candidate threshold set comprises a candidate peak-shaving threshold, a candidate baseline-padding threshold, and a candidate load-shedding threshold, each first threshold is one of the candidate peak-shaving thresholds, the candidate load-shedding thresholds, and a contracted capacity, and each second threshold is one of a value of “0”, the candidate baseline-padding thresholds, and the contracted capacity.

4. The charge and discharge control apparatus of claim 1, wherein the adjustment time intervals are in a sequence, each adjustment time interval has a start-time point and an end-time point, the start-time point of each adjustment time interval is the end-time point of the previous adjustment time interval except for the first one of the adjustment time intervals, and the processing unit further performs the following operations for each of a plurality of preset threshold sets to determine the candidate threshold sets from the preset threshold sets:
determining, for each adjustment time interval, an electricity adjustment range for the energy storage system to adjust the electricity consumption of the electric loop in the adjustment time interval according to the load prediction curve, the adjustment objective corresponding to the adjustment time interval, the charge and discharge requirement, and the preset threshold set;
calculating, according to a reverse order of the sequence, an estimated energy storage range at the start-time point of each adjustment time interval based on an estimated energy storage range at the end-time point of the last one of the adjustment time intervals and the electricity adjustment range of each adjustment time interval; and
selecting the preset threshold set as one of the candidate threshold sets when the processing unit determines that all of the estimated energy storage ranges corresponding to the preset threshold set fall into an energy storage range of the energy storage system.

5. The charge and discharge control apparatus of claim 4, wherein the processing unit performs the following operation for each adjustment time interval to calculate the estimated energy storage range at the start-time point of the adjustment time interval:
calculating the estimated energy storage range at the start-time point of the adjustment time interval according to the estimated energy storage range of the energy storage system at the end-time point of the adjustment time interval, the electricity adjustment range, an upper threshold of the energy storage range, and a lower threshold of the energy storage range.

6. The charge and discharge control apparatus of claim 4, wherein the processing unit performs the following operation for each candidate threshold set at least once to generate the corresponding at least one candidate electricity adjustment scheme:
performing the following operations for each adjustment time interval according to the sequence:
determining an electricity adjustment amount within the electricity adjustment range corresponding to the adjustment time interval and the candidate threshold set so that an estimated energy storage of the energy storage system at the start-point of the adjustment time interval after being adjusted according to the electricity adjustment amount falls into the estimated energy storage range at the start-time point of a next adjustment time interval according to the sequence, and wherein if the adjustment time interval is the first one of the adjustment time intervals, the estimated energy storage of the start-time point of the adjustment time interval is an initial energy storage; and
setting the electricity adjustment amounts corresponding to the adjustment time intervals as one of the at least one candidate electricity adjustment scheme.

7. The charge and discharge control apparatus of claim 6, wherein the processing unit determines the initial energy storage from an initial energy storage range.

8. The charge and discharge control apparatus of claim 1, wherein the processing unit calculates an adjustment benefit indicator for each candidate electricity adjustment scheme, and determines the objective electricity adjustment scheme from the candidate electricity adjustment schemes according to the adjustment benefit indicators.

9. The charge and discharge control apparatus of claim 1, wherein the processing unit calculates a set indicator for each candidate threshold set, determines an objective threshold set according to the set indicators, calculates an adjustment benefit indicator for each candidate electricity adjustment scheme corresponding to the objective threshold set, and determines the objective electricity adjustment scheme from the candidate electricity adjustment schemes of the objective threshold set according to the adjustment benefit indicators.

10. A charge and discharge control method for an electronic computing apparatus, the electronic computing apparatus being adapted to control an energy storage system, the charge and discharge control method comprising:
determining a plurality of adjustment time intervals of a load prediction curve of an electric loop, wherein each adjustment time interval individually corresponds to an adjustment objective;
determining a plurality of candidate threshold sets according to the adjustment objectives and a charge and discharge requirement of the energy storage system, wherein each candidate threshold set corresponds to at least one candidate electricity adjustment scheme; and
determining an objective electricity adjustment scheme from the candidate electricity adjustment schemes so that the energy storage system adjusts the electricity consumption of the electric loop according to the objective electricity adjustment scheme in each adjustment time interval.

11. The charge and discharge control method of claim 10, wherein each adjustment objective comprises at least one of the following adjustment conditions:
in the adjustment time interval corresponding to the adjustment objective, having an adjusted load of the electric loop being not greater than a first threshold; and
in the adjustment time interval corresponding to the adjustment objective, having the adjusted load of the electric loop being not less than a second threshold.

12. The charge and discharge control method of claim 11, wherein each candidate threshold set comprises a candidate peak-shaving threshold, a candidate baseline-padding threshold, and a candidate load-shedding threshold, each first threshold is one of the candidate peak-shaving thresholds, the candidate load-shedding thresholds, and a contracted capacity, and each second threshold is one of a value of “0”, the candidate baseline-padding thresholds, and the contracted capacity.

13. The charge and discharge control method of claim 10, wherein the adjustment time intervals are in a sequence, each adjustment time interval has a start-time point and an end-time point, the start-time point of each adjustment time interval is the end-time point of the previous adjustment time interval except for the first one of the adjustment time intervals, and the charge and discharge control method further comprises:
performing the following steps for each of a plurality of preset threshold sets to determine the candidate threshold sets from the preset threshold sets:
determining, for each adjustment time interval, an electricity adjustment range for the energy storage system to adjust the electricity consumption of the electric loop in the adjustment time interval according to the load prediction curve, the adjustment objective corresponding to the adjustment time interval, the charge and discharge requirement, and the preset threshold set;
calculating, according to a reverse order of the sequence, an estimated energy storage range at the start-time point of each adjustment time interval based on an estimated energy storage range at the end-time point of the last one of the adjustment time intervals and the electricity adjustment range of each adjustment time interval; and
selecting the preset threshold set as one of the candidate threshold sets, when determining that all of the estimated energy storage ranges corresponding to the preset threshold set fall into an energy storage range of the energy storage system.

14. The charge and discharge control method of claim 13, further comprising:
performing the following step for each adjustment time interval to calculate the estimated energy storage range at the start-time point of the adjustment time interval:
calculating the estimated energy storage range at the start-time point of the adjustment time interval according to the estimated energy storage range of the energy storage system at the end-time point of the adjustment time interval, the electricity adjustment range, an upper threshold of the energy storage range, and an lower threshold of the energy storage range.

15. The charge and discharge control method of claim 13, further comprising:
performing the following steps for each candidate threshold set at least once to generate the corresponding at least one candidate electricity adjustment scheme:
performing the following step for each adjustment time interval according to the sequence:
determining an electricity adjustment amount within the electricity adjustment range corresponding to the adjustment time interval and the candidate threshold set so that an estimated energy storage of the energy storage system at the start-point of the adjustment time interval after being adjusted according to the electricity adjustment amount falls into the estimated energy storage range at the start-time point of a next adjustment time interval according to the sequence, and wherein if the adjustment time interval is the first one of the adjustment time intervals, the estimated energy storage of the start-time point of the adjustment time interval is an initial energy storage; and
setting the electricity adjustment amounts corresponding to the adjustment time intervals as one of the at least one candidate electricity adjustment scheme.

16. The charge and discharge control method of claim 15, further comprising:
determining the initial energy storage from an initial energy storage range.

17. The charge and discharge control method of claim 10, wherein the step of determining the objective electricity adjustment scheme comprises:
calculating an adjustment benefit indicator for each candidate electricity adjustment scheme; and
determining the objective electricity adjustment scheme from the candidate electricity adjustment schemes according to the adjustment benefit indicators.

18. The charge and discharge control method of claim 10, wherein the step of determining the objective electricity adjustment scheme comprises:
calculating a set indicator for each candidate threshold set;
determining an objective threshold set according to the set indicators;
calculating an adjustment benefit indicator for each candidate electricity adjustment scheme corresponding to the objective threshold set; and
determining the objective electricity adjustment scheme from the candidate electricity adjustment schemes of the objective threshold set according to the adjustment benefit indicators.
